(19) United States
(12) Patent Application Publication
(10) Pub. No.: US 2025/0052110 A1
(43) Pub. Date: Feb. 13, 2025

(54) GLAZING UNIT

(71) Applicant: Pilkington Group Limited, Lathom (GB)

(72) Inventor: Marcel RIBBERINK, Enschede (NL)

(73) Assignee: Pilkington Group Limited, Lathom (GB)

(21) Appl. No.: 18/718,529

(22) PCT Filed: Dec. 15, 2022
(86) PCT No.: PCT/GB2022/053238

§ 371 Date: Jun. 11, 2024

(30) Foreign Application Priority Data
Dec. 16, 2021 (GB) 2118262.1

(51) Int. Cl. E06B 9/264; E06B 3/677; E06B 9/30

(52) U.S. Cl. CPC E06B 9/264; E06B 3/677; E06B 9/30

(57) ABSTRACT

A glazing unit includes a physically adjustable element wherein the glazing unit is adapted for reducing binding of the physically adjustable element, the glazing unit including one or more sensors and a heatable coating. Also provided is a process for manufacturing such a glazing unit, a system comprising such a glazing unit, and the use of such a glazing unit or such a system in a building.

The present invention relates to a glazing unit. More particularly, the invention relates to a glazing unit comprising a physically adjustable element, a process for manufacturing such a glazing unit, a system comprising such a glazing unit, and the use of such a glazing unit or such a system in a building.

Glazing units are often provided in building envelopes to allow light from the sun to enter the interior of the building, and for occupants to view the building environment. However, in some cases light incident on the unit may be particularly intense, such that maintaining the temperature of a room associated with the glazing unit at a comfortable level may be difficult.

It is known to use blinds to adjust the amount of light and/or heat that is transmitted by a glazing unit. For example, WO 2008149278 A1 discloses a window element comprising panes between which a window blind is arranged and U.S. Pat. No. 9,080,376 B2 discloses a Venetian blind with a series of slats inside a glass-enclosed chamber, wherein the slats comprise a reflective layer.

However, the inventors have discovered that under some conditions physically adjustable elements installed within a glazing unit cavity, such as slats and roller blinds, may bind upon the glazing sheets such that they do not move smoothly. In some cases, the physically adjustable elements may become stuck, such that they can no longer be adjusted, which may necessitate replacement of the glazing unit itself.

One previous method to overcome the issue of physically adjustable elements binding within glazing cavities has been to select physically adjustable elements that are of significantly reduced size compared to the distance between the glazing sheets, also known as the cavity width. However, this reduces the choices available to the glazing unit assembler and may require the use of less preferred physically adjustable elements.

Therefore, it is an object of the present invention to provide an alternative glazing unit comprising a physically adjustable element that is better able to reduce the incidence of binding of the physically adjustable element.

According to a first aspect of the invention there is provided a glazing unit comprising:
a first sheet of glazing material comprising a first face and a second face;
a second sheet of glazing material comprising a first face and a second face;
a cavity comprising a gas between the first and second sheets of glazing material;
a physically adjustable element at least partially within the cavity;
a heatable coating suitable for heating the gas; and
one or more sensors,
wherein the second faces of the first and second sheets of glazing material are orientated towards the cavity, and wherein:
the adjustment of the physically adjustable element is reversibly restrictable based on information from the one or more sensors; and/or
the heatable coating is reversibly activatable based on information from the one or more sensors.

The inventors have learned that the incidence of binding of physically adjustable elements upon glazing sheets is significantly increased when there is a pressure imbalance between the glazing unit cavity and the glazing unit environment. In particular, when the atmospheric pressure of the glazing unit environment is significantly higher than the gas pressure of the glazing unit cavity gas one or more sheets of glazing material may deflect into the cavity. Such deflection of a sheet of glazing material into the cavity is known as a “bowing mode”. When the glazing unit is in a bowing mode, the deflected sheet of glazing material may be in the path of the physically adjustable element's movement and/or rotation, causing binding to occur.

It was observed that glazing units are particularly susceptible to bowing modes during the winter, and especially during winter at low altitudes. During winter the temperature of the cavity gas is reduced, potentially reducing the pressure of the cavity gas below the atmospheric pressure of the glazing unit environment. The pressure difference causes the sheets of glazing material to deflect.

It was also observed that glazing units may be susceptible to bowing modes due to wind loading.

The inventors realised that the presence of a heatable coating suitable for heating the gas within the cavity allows for the temperature of the cavity gas to be increased. The increase in temperature is associated with an increase in pressure, reducing the imbalance between the internal and external pressures and may thereby relieve, or even eliminate, the bowing mode and thereby prevent binding of the physically adjustable element.

Preferably, the adjustment of the physically adjustable element is reversibly restrictable based on information from the one or more sensors. As such, the glazing unit preferably comprises means suitable for restricting the adjustment of the physically adjustable element when receiving information directly from the one or more sensors, or via a controller, and such means may be applied in a reversible manner. Restriction of the adjustment of the physically adjustable element may prevent movement and/or rotation, and thereby prevent binding of the physically adjustable element with a sheet of glazing material.

During use the heatable coating may be manually activated. Alternatively, it may be activated during use based on timers, and/or weather data.

Preferably, the heatable coating is activated during use, and therefore is reversibly activatable, based on information from the one or more sensors. The heatable coating may be activatable based on information directly received from the one or more sensor, or information received from the one or more sensor via a controller. The heatable coating may be activated for a predetermined period of time upon receiving information from the one or more sensors. Alternatively or in addition, the heatable coating may be deactivated based on information directly received from the one or more sensor, or information received via a controller. Alternatively or in addition, the heatable coating may be deactivated based on a timer.

In a particularly preferred embodiment, the adjustment of the physically adjustable element is reversibly restrictable based on information from the one or more sensors and the heatable coating is reversibly activatable based on information from the one or more sensors. This allows a feedback process to be initiated, wherein information from the one or more sensors causes a restriction of the physically adjustable element to be initiated and the heatable coating to be activated, which increases the gas pressure of the cavity gas, and then information from the one or more sensors causes the restriction of the physically adjustable element to be ceased. In this process the heatable coating may be deactivated based on a timer, or is preferably deactivated based on information from the one or more sensors. Such a feedback process is particularly beneficial to the end user, as very little, or even no, interaction of the end user with the process is required to provide the desired outcome.

Means for restricting the adjustment of the physically adjustable element are not particularly limited but preferably the glazing unit further comprises stops, springs, and/or motors suitable for restricting the adjustment of the physically adjustable element.

The position of the heatable coating is not particularly limited, but preferably the heatable coating is associated with a sheet of glazing material, in that a sheet of glazing material comprises the heatable coating upon a surface. Heatable coatings associated with sheets of glazing materials may be produced economically and with very high heat output.

Preferably, the heatable coating is associated with an internal surface of the glazing unit, i.e. in some embodiments the second face of the first sheet of glazing material and/or the second face of the second sheet of glazing material comprise the heatable coating. It is beneficial for the heatable coating to be upon a face of a sheet of glazing material orientated towards the interior of the glazing unit, as this protects the heatable coating from the glazing unit environment.

Alternatively, the heatable coating may be associated with external surfaces of the glazing unit, i.e. in some embodiments the first faces of the first and or second sheets of glazing material may be provided with the heatable coating. However, where the heatable coating is associated with external surfaces of the glazing unit it is preferred that the heatable coating comprises an insulating overlayer to prevent electrical short circuit and/or electric shock.

The glazing unit further comprises one or more sensors. The inventors realised that by installing one or more sensors in the glazing unit, the glazing unit may be readily assessed to check for the presence of a bowing mode. The sensors may provide information to one or more other elements of the insulated glazing unit, and/or to elements of a system comprising the insulated glazing unit, as disclosed below.

Preferably at least one of the one or more sensors is at least partially between the first sheet of glazing material and the second sheet of glazing material. This may allow the at least one of the one or more sensors to assess a parameter between the first and second sheets of glazing material. Preferably at least one of the one or more sensors is at least partially between the first sheet of glazing material and the second sheet of glazing material, and partially within the cavity. This may allow the at least one of the one or more sensors to assess a parameter between the first and second sheets of glazing material within the cavity.

Alternatively, one or more sensors may be applied to external surfaces of the insulated glazing unit. This provides the advantage that they may be applied after the glazing unit has been constructed, which may reduce manufacturing complexity. In addition, this may obviate the requirement to supply power and/or retrieve information from sensors between glazing unit sheets of glazing material, which may require piercing sealants around the insulated glazing unit, again increasing manufacturing complexity and also potentially introducing moisture into the glazing unit cavity. Where one or more sensors are applied to external surfaces of the insulated glazing unit, it is preferred that a first sensor is applied to a first external surface to be orientated towards the building environment following installation, and a second sensor is applied to a second external surface to be orientated towards the building interior following installation, and that the insulated glazing is installed within a system that comprises a controller that may estimate a parameter within the cavity supplied with the physically adjustable element based on sensor data from the first and second sensors.

Preferably, the one or more sensors comprise a pressure sensor and/or a glass pane deflection sensor and/or a temperature sensor. A pressure sensor may assess the gas pressure of the glazing unit cavity. Alternatively or in addition, a pressure sensor may assess the atmospheric pressure of the glazing unit environment. Preferably the pressure sensor is an absolute pressure sensor or a relative pressure sensor. A glazing material sheet deflection sensor may assess the deflection of the first and/or second sheets of glazing material. A temperature sensor may assess the temperature of the cavity gas. Alternatively or in addition, a temperature sensor may assess the temperature of the glazing unit environment. The one or more sensors may be supplied with energy by wires from outside the glazing. Alternatively, the one or more sensors may comprise one or more photovoltaic cells, or the glazing may comprise one or more photovoltaic cells, suitable for supplying the one or more sensors with energy.

Preferably, the glazing unit further comprises a feedback device activatable based on information from the one or more sensor. The feedback device may be activated directly by information from the one or more sensor, or may be controlled by a controller that receives information from the one or more sensor and then activates the feedback device. The feedback device may provide feedback to the glazing unit user that the physically adjustable element should not be adjusted because the risk of binding is high, based on information received from the one or more sensor. Alternatively or in addition, where the glazing unit comprises means for restricting the movement of the physically adjustable element based on information received from the one or more sensor, the feedback device may provide feedback to the glazing unit user that the physically adjustable element cannot currently be adjusted because the risk of binding is high. Alternatively or in addition, where the glazing unit comprises means activating the heatable coating based on information received from the one or more sensor, the feedback device may provide feedback to the glazing unit user that the heatable coating has been activated. Feedback devices are well known to skilled persons, but preferably, the feedback device comprises a light emitting device, preferably an LED, and/or a sound emitting device, preferably a speaker. The feedback device may be supplied with energy by wires from outside the glazing. Alternatively, the feedback device may comprise one or more photovoltaic cells, or the glazing may comprise one or more photovoltaic cells, suitable for supplying the feedback device with energy.

The glazing unit comprises a heatable coating suitable for heating the gas.

The material of the heatable coating is not particularly limited, but in most embodiments will comprise a conductive layer. Preferably, the heatable coating comprises a transparent conductive layer comprising a transparent conductive oxide, TCO, preferably comprising fluorine doped tin oxide, FTO, indium tin oxide, ITO, or antinomy doped tin oxide, ATO, most preferably fluorine doped tin oxide, FTO. Such transparent conductive oxides provide high light transmission and good electrical conductivity for heating applications. Preferably, the heatable coating comprises an amorphous or crystalline layer of a transparent conductive oxide, TCO. A suitable example of a TCO coating for use in accordance with the first aspect of the present invention includes NSG TEC™, available from Nippon Sheet Glass Co., Ltd.

Alternatively, the heatable coating comprises a transparent conductive layer comprising a noble metal, preferably silver.

The heatable coating may comprise one or more additional underlayers between the substrate and a conductive layer. Such underlayers may comprise, for example, silicon and/or aluminium oxides, silicon and/or aluminium nitrides, silicon and/or aluminium oxynitrides, nickel, chrome, tin and/or zinc and/or zirconium. Such underlayers may be provided to improve the adhesion and/or durability of the heatable coating. Preferably, the heatable coating comprises, in order from the substrate, a layer of tin oxide, a layer of silicon oxide, and a layer of fluorine doped tin oxide.

The heatable coating may comprise one or more overlayers, such that the transparent conductive layer is between the substrate and the one or more overlayer coatings. Such coatings may comprise, for example, silicon and/or aluminium oxides, silicon and/or aluminium nitrides, silicon and/or aluminium oxynitrides, nickel, chrome, tin and/or zinc and/or zirconium. Such overlayers may be provided to improve the durability of the heatable coating, and/or to electrically isolate the physically adjustable element and the transparent conductive layer of the heatable coating and thereby prevent short circuit and damage to the glazing unit.

Preferably, where a heatable coating is associated with a cavity comprising a physically adjustable element, the heatable coating comprises an overlayer, in particular preferably the heatable coating comprises, in order from the substrate, a layer of tin oxide, a layer of silicon oxide, a layer of fluorine doped tin oxide, and a layer of silicon oxide.

Preferably, the heatable coating is provided with busbars and/or connectors suitable for applying a voltage across the heatable coating and thereby causing resistive heating.

The heatable coating may be supplied with energy by wires from outside the glazing. Alternatively, the glazing unit may comprise one or more photovoltaic cells suitable for supplying the heatable coating with energy.

The glazing unit comprises a first sheet of glazing material and a second sheet of glazing material, and the second faces of the first and second sheets of glazing material are orientated towards the cavity.

Preferably, the first sheet of glazing material and/or the second sheet of glazing material comprise glass. Glass provides rigidity which may reduce the deflection of the sheet of glazing material, as well as providing excellent optical qualities. Preferably the first and/or second sheet of glazing material comprises soda-lime-silica glass. Preferably, the first sheet and/or second sheet of glazing material comprise low-iron soda-lime-silica glass. Low-iron soda-lime-silica glass preferably comprises 1 weight % or less iron. More preferably the low-iron soda-lime silica glass comprises 0.1 weight % or less iron. Most preferably, the low-iron soda-lime silica glass comprises 0.03 weight % or less iron. An example of a suitable low-iron soda-lime-silica glass for use in accordance with the first aspect of the present invention is Pilkington Optiwhite™, available from Nippon Sheet Glass Co., Ltd.

Whilst the sheets of glazing material preferably comprise glass, alternative glazing materials may comprise resin, such as a polycarbonate resin. A glazing material which comprises resin may provide increased impact resistance.

In some cases, the first sheet of glazing material and/or the second sheet of glazing material may comprise a laminated sheet of glazing material, wherein two or more sheets are adhered together to form a single glazing sheet. In some embodiments the laminated sheet of glazing material may comprise laminated glass. Preferably, the laminated glass comprises two sheets of glass with a sheet of interlayer material adhered between them. Preferably the sheet of interlayer material comprises a polymeric material. Suitable polymeric materials may be selected from one or more of, but not limited to: polyvinyl butyral (PVB); ethylene-vinyl acetate (EVA), a cast-in place resin; or another suitable interlayer material.

Preferably, the first sheet of glazing material and/or the second sheet of glazing material comprise laminated glass. Laminated glass provides even greater rigidity which may reduce the deflection of the sheet of glazing material. As such it is preferred that one, or even both, sheets of glazing material associated with the glazing cavity comprising a physically adjustable element comprise laminated glass. In addition, where a heatable coating is associated with a cavity comprising a physically adjustable element, it may be preferable that the heatable coating is applied to a surface within the laminated sheet of glazing material, to prevent contact between the heatable coating and the physically adjustable element, which may cause short circuits during use.

The glazing unit comprises a cavity comprising a gas between the first and second sheets of glazing material. Preferably, the gas comprises argon and/or nitrogen, most preferably at least 90% by volume argon and/or nitrogen.

The glazing unit comprises a physically adjustable element at least partially within the cavity. The physically adjustable element is adjustable in that at least one member of the physically adjustable element may be reversibly adjusted in space. Such adjustment in space may allow the element to move and/or rotate in a vertical plane and/or in horizontal planes following installation, as required by the user. The physically adjustable element may be an optically adjustable element, which reversibly adjusts the amount of visible light passing through the glazing unit.

Preferably, the physically adjustable element comprises one or more of: a roller blind; one or more slats; one or more pleats; or a combination thereof. A physically adjustable element comprising one or slats may be termed a “venetian blind”. Such physically adjustable elements, and especially those comprising one or more slats, provide a large degree of control to the end user of the transmission of light through the glazing unit.

However, the physically adjustable element may alternatively comprise displays or other items suspended within the cavity of glazing unit.

Where the physically adjustable element comprises one or more slats, preferably the one or more slats preferably comprise metal. The one or more slats may preferably comprise hardened aluminium alloy; preferably an aluminium magnesium alloy. Preferably, the one or more slats comprise from 4 to 5 weight % magnesium. Smaller percentages of other metallic or non-metallic elements such as, for example, but not limited to, copper, iron, nickel, silicon, phosphorus may also be present. Preferably, the one or more slats comprise two elongate surfaces. The one or more slats are preferably of a thickness in the region of 0.2 mm. Preferably, the one or more slats are formed by moulding a rolled strip of metal. Suitable slats for use in connection with the present invention are described in U.S. Pat. No. 9,080,376 B2, details of which are incorporated herein by reference.

Preferably the one or more slats are arranged with their longest axis substantially parallel to the second face of the second glazing pane.

Where the glazing comprises slats, the slats may be preferably provided with rotating means for adjusting the slats, and such rotating means may be preferentially provided with stops. Such stops may, for example, comprise mechanical mechanisms such as physical slots or spring mechanisms. Alternatively, the stops may be controlled by an electrical system. Preferably, the rotating means is an electric motor, and the stops are controlled by an electrical controller. Preferably, the electrical controller may automatically rotate the slats to prevent binding.

In addition, the one or more slats may be preferably provided with rotating means for adjusting the slats. Such means may include for example motors, rotors and levers.

In addition, where there is a series of slats, the glazing unit may be preferably provided with a means for collecting the slats to increase the amount of light transmitted by the glazing unit. Preferably, the slats are collected at an edge of the cavity. Such collecting means may include for example, but is not limited to, motors, rotors, pull cords and levers. Preferably, an electrical controller may automatically limit the movement of the slats to prevent binding.

Preferably, the cavity is sealed by at least one spacer bar. The cavity may be sealed by two or more spacer bars. The use of one or more spacer bars in the glazing of the present invention may preferably maintain the cavity. The one or more spacer bars may be preferably penetrated partially or completely by the sheets of glazing material, depending on the design of the glazing unit.

Spacer bars maintain the distance between the sheets of glazing material, thus the width of the spacer bar is determining factor in the distance between the sheets of glazing material, and therefore influences the volume of the cavity and the effect of pressure imbalances between the cavity gas pressure and the atmospheric pressure of the glazing unit environment. Therefore, preferably spacer bars have a width, w, of from 4 to 35 mm, preferably a width, w, of from 12 to 30 mm. Cavities comprising physically adjustable elements preferably are associated with spacer bars having a width, w, of from 12 to 30 mm. When a wider spacer is used, for example a width, w, greater than 18 mm, more preferably greater than 24 mm, and especially in larger windows, the influence of reduced cavity gas pressure is more pronounced, leading to an increased need to remedy or prevent any binding of the physically adjustable element, as exemplified by the present application.

Preferably, the glazing unit comprises three or more sheets of glazing material separated by two or cavities. Such a glazing unit construction comprising three sheets of glazing material and two cavities is termed “triple glazed” and improves the thermal performance of the glazing unit. Some glazing unit cavities may be provided with insulating gas or vacuum, in order to further improve the thermal properties of the glazing unit.

The heatable coating may be associated with a first cavity and the physically adjustable element is associated with the same cavity. However, preferably the heatable coating is associated with a first cavity and the physically adjustable element is associated with a second cavity, and the first and second cavities are different. This simplifies the construction of the glazing, as laminated panes and overlayers are not required to isolate the heatable coating from the physically adjustable element.

Preferably, a sheet of glazing material comprises a solar control coating, preferably a solar control coating comprising silver. Alternatively, solar control coatings comprising transparent oxides, preferably fluorine doped tin oxide, FTO, may be used. Such coatings improve the thermal performance of the glazing unit. It is preferred that such solar control coatings are orientated towards a glazing unit cavity, to protect them during use of the glazing unit. However, in some cases solar control coatings may be applied to external faces of the glazing unit, that is those faces that are orientated towards the interior of the building or the building environment.

The thickness of the solar control coating may be adjusted to provide specific solar control and light transmittance properties. In addition, individual layers within a multi-layered stack may be similarly adjusted, for example to achieve colour neutrality. A suitable solar control coating example for use in accordance with the first aspect of the present invention is Pilkington K Glass™, or Pilkington Suncool™, or Pilkington Optitherm™, available from Nippon Sheet Glass Co., Ltd.

Preferably, a sheet of glazing material comprises a functional coating applied to external faces of the glazing unit, that is those faces that are orientated towards the interior of the building or the building environment.

Preferably, where the functional coating comprises a self-cleaning coating, the self-cleaning coating comprises titanium dioxide, TiO₂; preferably TiO₂ with a predominantly anatase crystal structure. A suitable example of a self-cleaning coating for use in accordance with the first aspect of the present invention is Pilkington Activ™, available from Nippon Sheet Glass Co., Ltd. The self-cleaning coating may be manufactured as described by U.S. Pat. No. 6,238,738 B1, the details of which are incorporated herein by reference.

Preferably, where the functional coating is an anti-reflection coating, the anti-reflection coating comprises a first dielectric layer and a second dielectric layer. A suitable anti-reflection coating example for use in accordance with the first aspect of the present invention is Pilkington OptiView™, available from Nippon Sheet Glass Co., Ltd. The anti-reflection coating may be manufactured as described by U.S. Pat. No. 5,935,716 A, the details of which are incorporated herein by reference.

Alternatively, the functional coating is a non-marking coating. The non-marking coating may preferably comprise a fluorinated alkylsilane polymer. A suitable non-marking coating example for use in accordance with the first aspect of the present invention is Clarity Ultraseal™, available from Nanofilm, Valley View, Ohio, USA.

When coatings are applied to sheets of glazing material one or more of the coatings may be applied for example by chemical vapour deposition (CVD). This method may allow a large surface area to be coated at a high rate. Alternatively, one or more of the coatings may be applied by physical vapour deposition, such as sputtering. Physical vapour deposition (PVD) may be used to deposit coating compositions which are preferably deposited by PVD. Alternatively, one or more of the coatings may be applied by liquid deposition techniques such as, for example, slot-die, doctor blade, spray or roller coating. Liquid deposition techniques may be used to deposit coating compositions in place of CVD or PVD techniques as required.

In some cases, the glazing unit further comprises a photovoltaic element. The photovoltaic element preferably comprises one or more of: a thin film photovoltaic element; a silicon photovoltaic element; a cadmium telluride photovoltaic element; a perovskite photovoltaic element; one or more strip photovoltaic elements; or a combination thereof, as disclosed in WO 2019092458 A1.

Although not contemplated in detail in this application, the glazing unit may require seals. The seals may be both peripheral and internal, and may be used to, for example, prevent the ingress of moisture into the glazing unit. Alternatively, such seals may be used to prevent the escape of insulating gas from the cavity or simply to retain glazing sheets within the glazing unit.

Preferably the glazing unit is an insulating glazing unit (IGU). Preferably the IGU comprises a U-value of less than or equal to 3 W/m²K, preferably less than 1.5 W/m²K. U-value is a measure of heat gain or loss through the insulating glazing unit due to environmental differences between the outdoor and indoor air. A lower U-value means that less heat is lost from the building's interior to its exterior, resulting in savings in energy costs.

The glazing unit may also comprise electrical apparatus such as electrical leads, connectors, junction boxes, controllers, and wireless communication systems known in the art in order for the heatable coating to be activated, and/or for the one or more sensors to function, once the glazing unit is installed. Such electrical apparatus may preferably be positioned within or at the glazing unit edge, or a spacer bar, to prevent a reduction in transparency of the glazing unit.

The glazing unit may also comprise additional sensors, such as humidity and light sensors which are known to the skilled person, for monitoring the glazing unit and or environment of the glazing unit.

Preferably, the glazing unit further comprises an electrical controller suitable for:
receiving information from the one or more sensors;
controlling the restriction of the physically adjustable element; and
controlling the activation of the heatable coating.

Controlling the restriction of the physically adjustable element may include initiating restriction, ceasing restriction, and optionally incorporating timed initiations, restrictions and pauses.

Controlling the activation of the heatable coating may include activating, deactivating, and optionally incorporating timed activations, deactivations and pauses.

The controller may include pattern recognition abilities, such that information from the one or more sensors is stored and used to provide patterns, which in turn may be used to reversibly restrict the adjustment of the physically adjustable element and/or reversibly activate the heatable coating. Pattern recognition abilities may include neural networks, machine learning algorithms and the like.

According to a second aspect of the present invention there is provided a process for manufacturing a glazing unit according to the first aspect, wherein, prior to forming the glazing unit, a physically adjustable element is positioned between the first sheet of glazing material and the second sheet of glazing material.

According to a third aspect of the present invention, there is provided a system comprising the glazing unit according to the first aspect, or the glazing unit manufactured according to the second aspect, further comprising an electrical controller suitable for:
receiving information from the one or more sensors;
controlling the physically adjustable element; and
controlling the heatable coating.

The controller may be integrated into the glazing unit, that is the glazing unit may comprise the controller. Alternatively, the controller may be external to the glazing unit, but communicate with it in order to receive information from the one or more sensors and to control aspects of the glazing unit. The controller may be in electrical communication with the glazing unit and elements of the glazing unit such as the physically adjustable element and/or the heatable coating via wires, or wirelessly, or a combination.

Controlling the restriction of the physically adjustable element may include initiating restriction, ceasing restriction, and optionally incorporating timed initiations, restrictions and pauses.

Controlling the activation of the heatable coating may include activating, deactivating, and optionally incorporating timed activations, deactivations and pauses.

Preferably the system further comprises a wind speed sensor, wherein the electrical controller is suitable for receiving information from the wind speed sensor. The wind speed sensor may be integrated into the glazing unit, that is the glazing unit may comprise the wind speed sensor. Alternatively, the wind speed sensor may be external to the glazing unit.

Alternatively or in addition, the system may comprise: a pressure sensor; and/or a glazing material sheet deflection sensor; and/or a temperature sensor.

The wind speed sensor and/or the pressure sensor and/or the glazing material sheet deflection sensor and/or the temperature sensor may be in electrical communication with the controller via wires, or wirelessly, or a combination. For example, the wind speed sensor and/or the pressure sensor and/or the temperature sensor may be associated with a weather station in the environment of the glazing unit.

In addition, the controller may comprise a receiver which is suitable for receiving data from external sources, such as weather system data from weather stations, weather services and the like.

The controller may include pattern recognition abilities, such that information from the one or more sensors is stored and used to provide patterns, which in turn may be used to reversibly restrict the adjustment of the physically adjustable element and/or reversibly activate the heatable coating. Pattern recognition abilities may include neural networks, machine learning algorithms and the like.

According to a fourth aspect of the present invention there is provided the use of a glazing unit according to the first aspect, of a glazing unit manufactured according to the second aspect, or of the system according to the third aspect, in a building for controlling the pressure of the gas in the cavity.

A building comprises a building interior and an envelope, the envelope separating the building interior from the building environment, and the glazing unit may be situated within the building envelope. The glazing unit may be incorporated into a window, door, rooflight, or other building product.

Preferably the glazing unit is installed in the building such that a cavity comprising a physically adjustable element is orientated towards the external environment. Where there are more than one cavity, a physically adjustable element in the cavity orientated towards the external environment will cause the greatest reduction in heat and/or visible light transmission through the glazing unit.

Preferably, the glazing unit is installed in the building such that the glazing unit is orientated such that the heatable coating is between the building interior and the physically adjustable element. A heatable coating that is between the building interior and the physically adjustable element will therefore have at least one cavity between the heatable coating and the building environment, which allows heat from the heatable coating to predominantly heat the building interior and the cavity, improving efficiency.

Most preferably, the glazing unit is installed in the building such that a cavity comprising a physically adjustable element is orientated towards the external environment and the heatable coating is between the building interior and the physically adjustable element.

The skilled person will appreciate upon consultation of this specification that optional features of the first, second, third and fourth aspects may be combined with one another and with other embodiments as necessary.

Embodiments of the present invention will now be described by way of example only with reference to the following accompanying drawings in which:

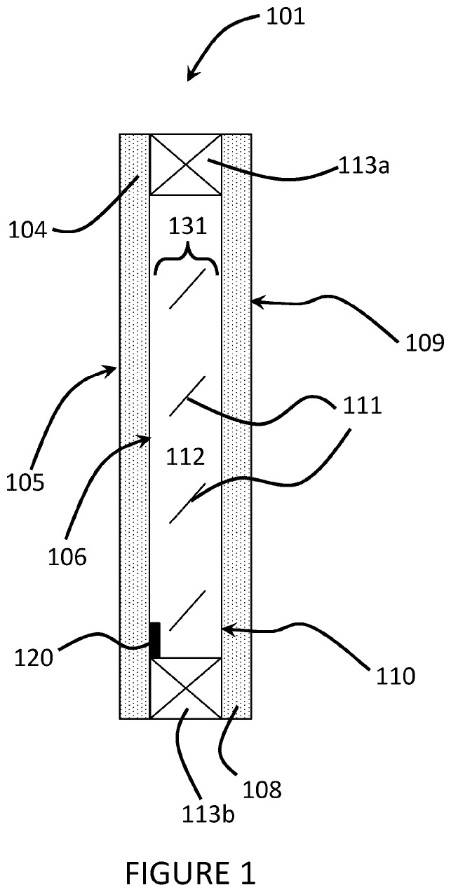

FIG. 1 illustrates a schematic cross-sectional view of a glazing unit according to a first embodiment of the present invention;

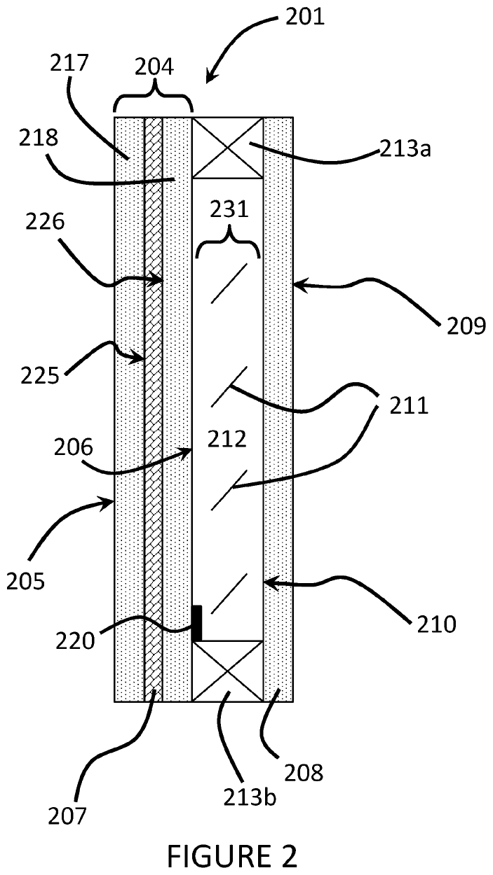

FIG. 2 illustrates a schematic cross-sectional view of a glazing unit according to a second embodiment of the present invention; and

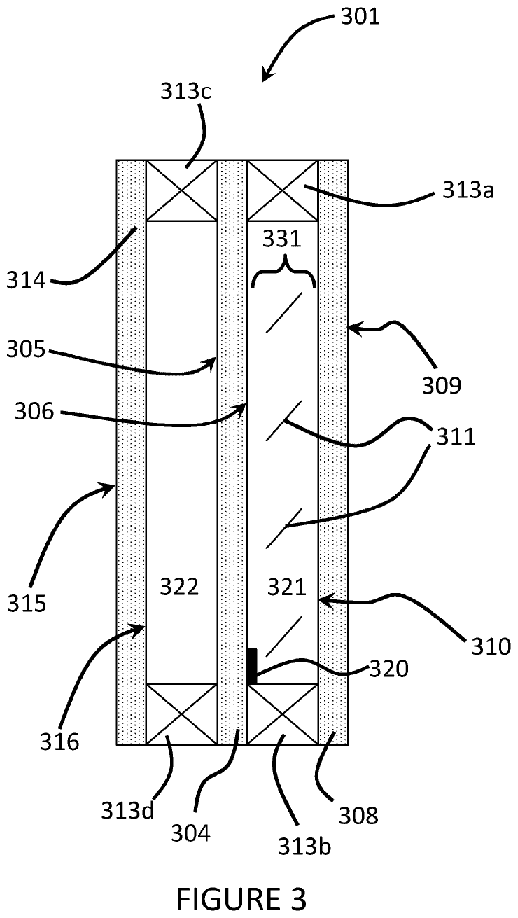

FIG. 3 illustrates a schematic cross-sectional view of a glazing unit according to a third embodiment of the present invention.

FIG. 1 represents a schematic cross-sectional view of a first embodiment of a glazing unit 101 according to the present invention. The glazing unit 101 comprises a physically adjustable element 131 and a first sheet of glazing material 104 with a first face 105 and a second face 106, and a second sheet of glazing material 108 with a first face 109 and a second face 110. A cavity 112 is located between the first 104 and second 108 sheets of glazing material, and comprises gas. The physically adjustable element 131 is positioned between the first sheet of glazing material 104 and the second sheet of glazing material 108, at least partially within the cavity 112.

In this first embodiment of the present invention, the cavity 112 is preferably defined by the second sheet of glazing material 108, the first sheet of glazing material 104, and spacer bars 113a and 113b. The physically adjustable element 131 is preferably secured within the cavity 112. In this embodiment the physically adjustable element 131 is a series of slats 111. The slats 111 may be formed from a metal, such as hardened aluminium alloy. The slats 111 may further comprise a reflecting coating—not shown—on one or both surfaces. The slats 111 are preferably provided with strings—not shown—for suspending the slats 111 within the cavity 112. The strings that suspend the slats also allow the slats to be rotated about their longest axis. This rotation allows the light transmission of the glazing unit 101 to be adjusted. The strings also allow the slats 111 to be condensed, preferably at an edge of the cavity 112.

The first 104 and second 108 sheets of glazing material are preferably formed from low-iron glass. Preferably, the first 104 and second 108 sheets of glazing material have a thickness of 6 mm. The glazing unit 101 comprises a heatable coating—not shown, preferably the second face 110 of the second sheet of glazing material 108 and/or the second face 106 of the first sheet of glazing material 104 comprises the heatable coating. The heatable coating preferably comprises fluorine-doped tin oxide. In this embodiment the heatable coating may be associated with a cavity comprising a physically adjustable element—in such a case preferably the heatable coating is provided with an overlayer for insulating a conductive layer of the heatable coating from the physically adjustable element.

Preferably, one or both of the first faces 105, 109 of the first 104 and second 108 sheets of glazing material further comprise a functional coating—not shown. The glazing unit 101 further comprises a sensor 120. In this embodiment the sensor 120 is at least partially between the first sheet of glazing material 104 and the second sheet of glazing material 108.

FIG. 2 represents a schematic cross-sectional view of a second embodiment of a glazing unit 201 according to the present invention. The glazing unit 201 comprises a first sheet of glazing material 204 which is a laminated pane.

The glazing unit 201 comprises a first sheet of glazing material 204 with a first face 205 and a second face 206, and a second sheet of glazing material 208 with a first face 209 and a second face 210. A cavity 212 is located between the first 204 and second 208 sheets of glazing material. A physically adjustable element 231 is positioned between the first sheet of glazing material 204 and the second sheet of glazing material 208.

In this second embodiment of the present invention the first sheet of glazing material 204 is a laminated pane comprising an interlayer 207 between two rigid plies 217, 218. Preferably, the interlayer 207 comprises PVB, and the rigid plies are glass or polycarbonate, preferably both being glass.

In this second embodiment of the present invention, the cavity 212 is preferably defined by the second sheet of glazing material 208, the first sheet of glazing material 204, and spacer bars 213a and 213b. The cavity 212 is provided with an insulating gas, such as one comprising argon.

The physically adjustable element 231 is preferably secured within the cavity 212. The physically adjustable element 231 in this embodiment is a series of slats 211. The slats 211 may be formed from a metal, such as hardened aluminium alloy. The slats 211 may further comprise a reflecting coating—not shown—on one or both surfaces. The slats 211 are preferably provided with strings—not shown—for suspending the slats 211 within the cavity 212. The strings that suspend the slats also allow the slats to be rotated about their longest axis. This rotation allows the transparency of the reflector to be adjusted relative to the light incident on the glazing unit 201. The strings also allow the slats of the physically adjustable element 211 to be condensed for example at an edge of the cavity 212, or in the region of the spacer bar 213a.

The second sheet of glazing material 208 and the rigid plies 217, 218 are each preferably formed from low-iron glass. Preferably, the second sheet of glazing material 208 and the rigid plies 217, 218 each have a thickness of 6 mm. The glazing unit 201 comprises a heatable coating—not shown, preferably the second face 210 of the second sheet of glazing material 208 and/or the second face 206 of the first sheet of glazing material 204 may comprise a heatable coating; the heatable coating preferably comprising fluorine-doped tin oxide.

In this embodiment the heatable coating may be associated with a cavity comprising a physically adjustable element—in such a case preferably the heatable coating is provided with an overlayer for insulating a conductive layer of the heatable coating from the physically adjustable element.

However, in constructions comprising only a single cavity, or wherein it is desirable to have both the physically adjustable element and the heatable coating associated with the same cavity, it is preferable for the heatable coating to be upon an internal face of a laminated sheet of glazing material. As such, in the embodiment depicted in FIG. 2, preferably an internal surface of the laminated sheet 225, 226 is provided with the heatable coating. This prevents the physically adjustable element from coming into contact with the heatable coating, which may cause short circuits and/or damage to the glazing unit.

Preferably, one or both of the first faces 205, 209 of the first 204 and second 208 sheets of glazing material further comprise a self-cleaning coating; the self-cleaning coating preferably comprising titanium dioxide.

The glazing unit 201 further comprises a sensor 220. In this embodiment the sensor 220 is at least partially between the first sheet of glazing material 204 and the second sheet of glazing material 208.

When installed in a glazing aperture in a building envelope, it is preferable that the glazing unit 201 is orientated such that the heatable coating is associated with the first sheet of glazing material and is between the building interior and the physically adjustable element 231, i.e. is on surface 205, 225, 226, 206.

FIG. 3 represents a schematic cross-sectional view of a third embodiment of a glazing unit 301 according to the present invention. The glazing unit 301 comprises a physically adjustable element 331, and is the form of a triple glazed construction, comprising three sheets of glazing material 304, 308, 314 separated by two cavities 321, 322.

The glazing unit 301 comprises a first sheet of glazing material 304 with a first face 305 and a second face 306, and a second sheet of glazing material 308 with a first face 309 and a second face 310. A first cavity 321 is located between the first 304 and second 308 sheets of glazing material. The physically adjustable element 331 is positioned between the first sheet of glazing material 304 and the second sheet of glazing material 308, at least partially within the first cavity 321.

In this third embodiment of the present invention the glazing unit 301 further comprises a third sheet of glazing material 314. The third sheet of glazing material 314 comprises a first face 315 and a second face 316. The third sheet of glazing material 314 forms a second cavity 322 with the first sheet of glazing material 304.

In this third embodiment of the present invention, the first cavity 321 is preferably defined by the first sheet of glazing material 304, the second sheet of glazing material 308, and spacer bars 313a and 313b. The second cavity 322 is preferably defined by the first sheet of glazing material 304, the third sheet of glazing material 314, and spacer bars 313c and 313d. The first cavity 321 is provided with gas such as one comprising argon or nitrogen. The second cavity 322 may be provided with gas, such as one comprising argon or nitrogen, or may comprise vacuum.

The physically adjustable element 331 is preferably secured within the first cavity 321. The physically adjustable element 331 is in this embodiment a series of slats 311. The slats 311 may be formed from a metal, such as hardened aluminium alloy. The slats 311 may further comprise a reflecting coating—not shown—on one or both surfaces. The slats 311 are preferably provided with strings—not shown—for suspending the slats 311 within the cavity 312. The strings that suspend the slats 311 may also allow the slats 311 to be rotated about their longest axis. This rotation allows the transparency of the glazing unit 301a to be adjusted relative to the light incident on the glazing unit. The strings also allow the slats 311 of the physically adjustable element 331 to be condensed towards spacer 313a for example, or at an edge of the first cavity 321.

The first 304, second 308, and third 314 sheets of glazing material are preferably formed from low-iron glass. Preferably, the first 304, second 308, and third 314 sheets of glazing material have a thickness of 6 mm. The glazing unit 301 comprises a heatable coating—not shown—upon one or more of surfaces 305, 306, 309, 310, 315, and/or 316, the heatable coating preferably comprising fluorine-doped tin oxide. In this embodiment the heatable coating may be associated with a cavity comprising a physically adjustable element—in such a case preferably the heatable coating is provided with an overlayer for insulating a conductive layer of the heatable coating from the physically adjustable element.

Preferably, one or both of the first faces 315, 309 of the third 314 and second 308 sheets of glazing material further comprise a self-cleaning coating; the self-cleaning coating preferably comprising titanium dioxide. Preferably, one or more of surfaces 316, 305, 306, 310 comprise a low-emissivity coating, preferably a low-emissivity coating comprising silver and/or fluorine doped tin oxide.

In a preferred embodiment, surfaces 305 and/or 310 comprise a low-emissivity coating, preferably comprising silver, surface 316 comprises a heatable coating, preferably comprising fluorine-doped tin oxide, and the glazing unit 301 is adapted to be installed in a building such that cavity 321 comprising the physically adjustable element 331 is orientated towards the building environment and cavity 322 is orientated toward the building interior.

It may be appreciated by the skilled person that any of the sheets of glazing material of the third embodiment may be replaced by a laminated pane as depicted by the second embodiment, and that additional panes and cavities, and the order of panes and cavities, may be adjusted to meet the requirements of the particular installation.

The glazing unit 301 further comprises a sensor 320. In this embodiment the sensor 320 is at least partially between the first sheet of glazing material 304 and the second sheet of glazing material 308.

The glazing unit 301 may be adapted by the skilled person by the addition of a further sheet of glazing material and additional cavity, to form a quadruple unit. In such a case, it is preferred that the further sheet of glazing material is joined to the third sheet of glazing material 314 by additional spacers, that the heatable coating is associated with the further sheet of glazing material, and that surfaces 310, 305, 315 are provided with low-emissivity coatings, and that the glazing unit is installed such that the further sheet of glazing material is orientated towards the building interior.

In addition, any of embodiments 1 to 3 may further comprise a photovoltaic element as described in WO 2019092458 A1.

Preferably, the glazing unit further comprises a low-emissivity coating, preferably a low-emissivity coating comprising silver. Such coatings are preferably applied to surfaces of sheets of glazing material which are orientated towards a cavity. With reference to the figures, surfaces 106, 110, 206, 210, 305, 306, 310, 316 may be provided with one or more low-emissivity coatings.

In relation to the present invention as described above, the inventors have surprisingly discovered that a glazing unit prepared to comprise a heatable coating suitable for heating a glazing unit cavity which comprises a physically adjustable element provides a surprising reduction in the incidence of binding of the physically adjustable element. This provides an improved ability to regulate the light transmission of the glazing unit, and reduces the incidence of costly repairs or replacements of the glazing unit.

1.-25. (canceled)

26. A glazing unit comprising:
a first sheet of glazing material comprising a first face and a second face;
a second sheet of glazing material comprising a first face and a second face;
a cavity comprising a gas between the first and second sheets of glazing material;
a physically adjustable element at least partially within the cavity;
a heatable coating suitable for heating the gas; and
one or more sensors,
wherein the second faces of the first and second sheets of glazing material are orientated towards the cavity, and wherein:
the adjustment of the physically adjustable element is reversibly restrictable based on information from the one or more sensors; and/or
the heatable coating is reversibly activatable based on information from the one or more sensors.

27. The glazing unit according to claim 26, further comprising means suitable for restricting the adjustment of the physically adjustable element, preferably such means comprising stops, springs, and/or motors.

28. The glazing unit according to claim 26, wherein the heatable coating is associated with a sheet of glazing material, preferably the second face of the first sheet of glazing material and/or the second face of the second sheet of glazing material comprises the heatable coating.

29. The glazing unit according to claim 26, wherein at least one of the one or more sensors is at least partially between the first sheet of glazing material and the second sheet of glazing material, preferably at least partially within the cavity.

30. The glazing unit according to claim 26, wherein the one or more sensors comprise:
a pressure sensor; and/or a glazing material sheet deflection sensor; and/or a temperature sensor.

31. The glazing unit according to claim 26, further comprising a feedback device activatable based on information from the one or more sensor.

32. The glazing unit according to claim 31, wherein the feedback device comprises a light emitting device, preferably an LED, and/or a sound emitting device, preferably a speaker.

33. The glazing unit according to claim 26, wherein the heatable coating comprises a transparent conductive layer comprising a transparent conductive oxide, TCO, preferably comprising: fluorine doped tin oxide, FTO; indium tin oxide, ITO; or antinomy doped tin oxide, ATO, most preferably comprising fluorine doped tin oxide, FTO.

34. The glazing unit according to claim 26, wherein the heatable coating comprises a transparent conductive layer comprising a noble metal, preferably silver.

35. The glazing unit according to claim 26, wherein the cavity is defined in part by at least one spacer.

36. The glazing unit according to claim 26, wherein the physically adjustable element comprises one or more of: a roller blind; one or more slats; one or more pleats, or a combination thereof.

37. The glazing unit according to claim 36, wherein the physically adjustable element comprises a venetian blind.

38. The glazing unit according to claim 26, wherein the first sheet of glazing material and/or the second sheet of glazing material comprise glass, preferably soda-lime silica glass.

39. The glazing unit according to claim 26, wherein the first sheet of glazing material and/or the second sheet of glazing material comprise a laminated sheet of glazing material.

40. The glazing unit according to claim 26, wherein the glazing unit comprises three of more sheets of glazing material separated by two or more cavities.

41. The glazing unit according to claim 26, wherein the heatable coating is associated with a first cavity and the physically adjustable element is associated with the same cavity.

42. The glazing unit according to claim 26, wherein the heatable coating is associated with a first cavity and the physically adjustable element is associated with a second cavity, and the first and second cavities are different.

43. The glazing unit according to claim 26, wherein a sheet of glazing material comprises a solar control and/or low-emissivity coating, preferably a solar control and/or low emissivity coating comprising silver or a transparent conductive oxide.

44. The glazing unit according to claim 26, wherein a sheet of glazing material comprises a functional coating applied to one or more external faces of the glazing unit, preferably the functional coating comprises a self-cleaning coating, an anti-reflection coating and/or a non-marking coating.

45. The glazing unit according to claim 26, further comprising a photovoltaic element.

46. The glazing unit according to claim 26, further comprising an electrical controller suitable for:
receiving information from the one or more sensors;
controlling the restriction of the physically adjustable element; and
controlling the activation of the heatable coating.

47. A process for manufacturing a glazing unit according to claim 26 wherein, prior to forming the glazing unit, a physically adjustable element is positioned between the first sheet of glazing material and the second sheet of glazing material.

48. A system comprising a glazing unit according to claim 26, further comprising an electrical controller suitable for:
receiving information from the one or more sensors;
controlling the restriction of the physically adjustable element; and
controlling the activation of the heatable coating.

49. A method comprising installing a glazing unit according to claim 26 in a building and utilizing the glazing unit to control the pressure of the gas in the cavity.

50. The method according to claim 49, wherein the glazing unit is installed in the building with a building interior and a building environment, and wherein the glazing unit is orientated such that the heatable coating is between the building interior and the physically adjustable element.
